(19) United States
(12) Patent Application Publication
(10) Pub. No.: US 2003/0111284 A1
(43) Pub. Date: Jun. 19, 2003

(54) Electrical driving apparatus for bicycle

(76) Inventors: Kuang-Yuan Chou, Taichung (TW); Ming-Che Yang, Changhua Hsien (TW); Jang-Yi Lee, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/013,548

(22) Filed: Dec. 13, 2001

(51) Int. Cl. B62D 61/02; B62K 11/00

(52) U.S. Cl. 180/220

(57) ABSTRACT

An electrical driving apparatus, which is to mount on a bicycle for driving the bicycle traveling, comprises a driven device is to mount on one side of a back wheel hub of the bicycle. Three secure pieces is to mount the driven device at the interior side to secure the driven device on a disk of the back wheel hub. A motor, which is driven by an electrical power, is to mount on a skeleton of the bicycle for providing a turning power, and a transmission device connects the motor and the driven device for transmitting the turning power of the motor to the driven device to drive the bicycle traveling forward.

### FIELD OF THE INVENTION

The present invention relates generally to a driving apparatus, and more particularly to an electrical driving apparatus for bicycle.

### BACKGROUND OF THE INVENTION

Bicycle is a convenient vehicle for a short distance transport. It saves energy resource and, more particularly, rider gets no trouble with traffic jam and parking in a big city. Bicycles have been brought to the market for hundreds of years. Many types of bicycles have been designed to make them more functional and more convenient. Wherein, an electrical driving bicycle, which has a motor on it for driving the bicycle to travel, such that rider has no need to drive the bicycle to travel by manpower. Conventional electrical driving bicycles usually fix the motor thereon initially in manufacture. But recently, there was an electrical driving apparatus to be mounted on a normal bicycle by user.

FIG. 1 and FIG. 2 show a conventional electrical driving apparatus for mounting on a normal bicycle, which comprises a base seat 90 for securing on the bottom side of a skeleton of the bicycle at the front side of a front chain wheel 91. A motor 92 fixes at the skeleton having a driving chain wheel 93 engaging with the chain 94 of the bicycle. An adjusting device 95 pivots on the base seat 90 and engages with the chain 94 forced by a torsion spring 96 for adjusting the tension of the chain 94. When start the motor 92, the driving chain wheel 93 will drive the chain 94 to turn, such that the back wheel (not shown) can be driven to turn to make the bicycle traveling forward.

However, there are some drawbacks in the prior art described-above.

1. When assembling the electrical driving apparatus on a bicycle, it must disassemble the chain 94, the front chain wheel 91, and the crank. It is a hard work for a general user.

2. When the motor drives the chain 94 to turn, in the same time, it will drive the front chain wheel 91 and the crank to turn too. That makes rider's feet had to move with the crank. There is no appropriate place for feet to rest.

3. The prior art needs a longer chain to meet the driving chain wheel 93 and the adjusting device 95. And the adjusting device 95 and the torsion spring 96 are essential elements in the prior art for preventing the chain 94 escaping from the front and back chain wheels when gearshift. That will increase the manufacture cost.

### SUMMARY OF THE INVENTION

The primary objective of the invention is to provide an electrical driving apparatus for bicycle, which can mount on a normal bicycle to drive it traveling.

Another objective of the invention is to provide an electrical driving apparatus for bicycle, when driving the bicycle to travel forward, the crank would not be turned along.

The third objective of the invention is to provide an electrical driving apparatus for bicycle, which is easy to assemble and has lower cost.

According to the objective of the invention, an electrical driving apparatus, which is to mount on a bicycle for driving the bicycle traveling, comprises a driven device is to mount on one side of a back wheel hub of the bicycle. A motor is to mount on a skeleton of the bicycle. The motor can provide a turning power by electrical power, and a transmission device connects the motor and the driven device for transmitting the turning power of the motor to the driven device to drive the bicycle traveling forward.

### BRIEF DESCRIPTION OF THE DRAWINGS

FIG. 1 shows an electrical driving apparatus for bicycle of prior art;

FIG. 2 shows an exploded view of FIG. 1;

FIG. 3 shows the structure sketch of the first prefer embodiment;

FIG. 4 shows the lateral view of the first prefer embodiment;

FIG. 5 shows the sectional view from the back side of the first prefer embodiment;

FIG. 6 shows the lateral view of the second prefer embodiment, and FIG. 7 shows sectional view from the back side of the second prefer embodiment.

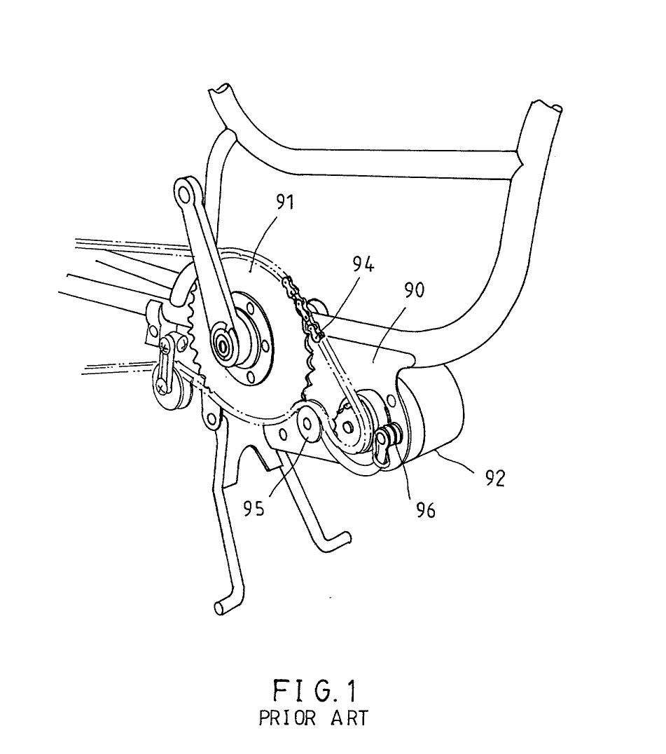

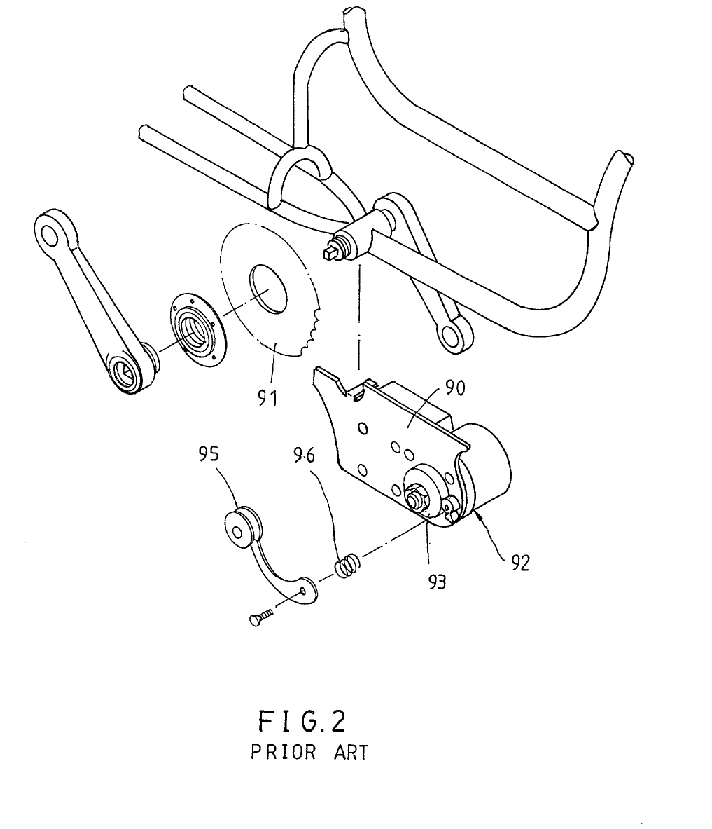

### DETAIL DESCRIPTION OF THE INVENTION

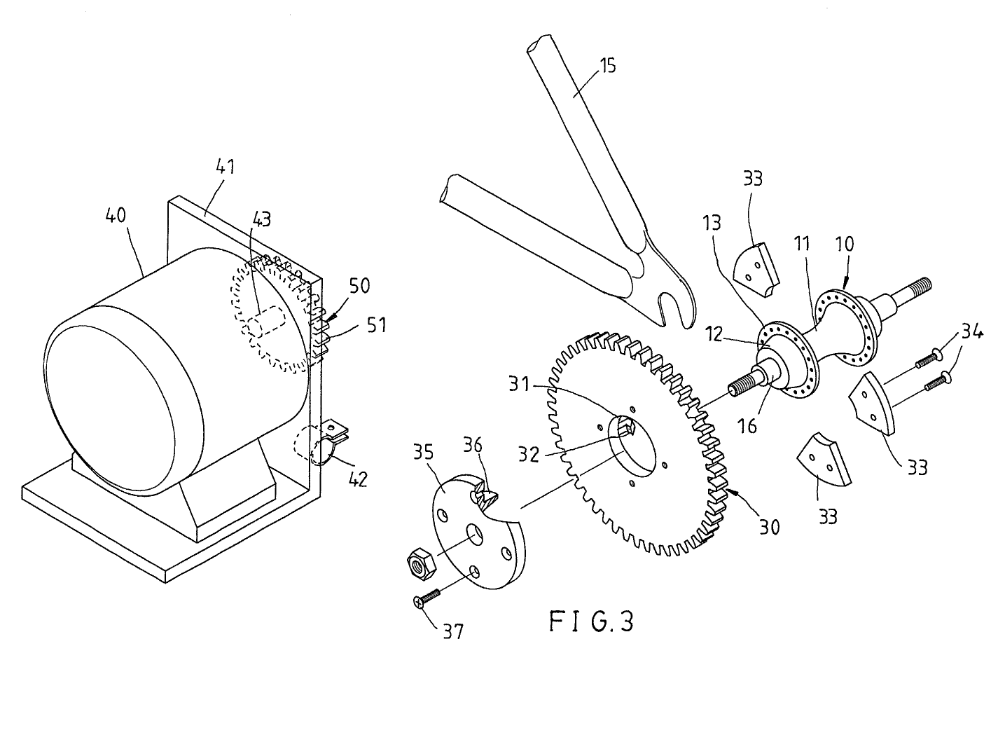

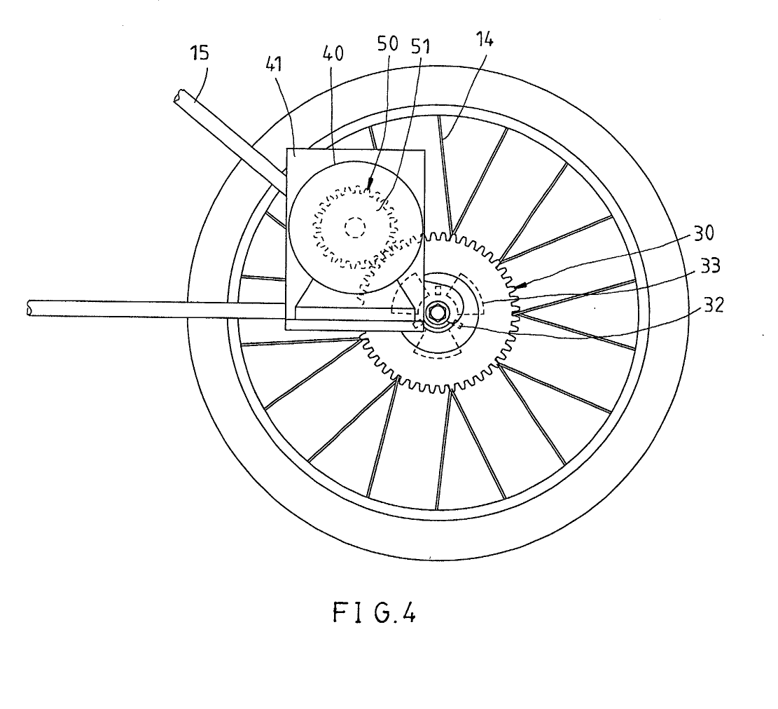

Before we start to describe the structure of the present invention, the structure of a conventional bicycle should be introduced here. Please refer to FIG. 3, the bicycle has a back wheel hub 10, which comprises a main axle 11 and two disks 13 respectively mounting at opposite sides of the main axle 11 for securing spokes 14. The outer sides of the disks 13 have a core 12 respectively. And at each of the outer sides of the cores 12, there is a shaft 16 respectively for securing the back wheel hub 10 on a skeleton 15 of the bicycle.

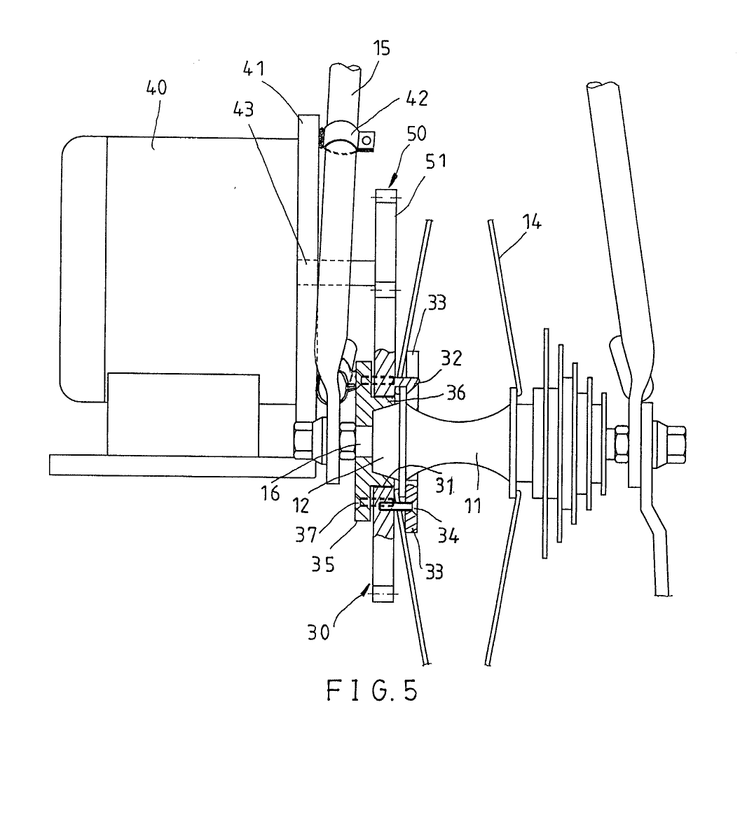

Now please refer to FIG. 3 to FIG. 5, an electrical driving apparatus 20 of the first prefer embodiment of the present invention for mounting on a bicycle, which comprises:

A driven device 30, which is a gear in this embodiment, has an axle hole 31 at the central thereof. The diameter of the axle hole 31 is larger than the proximal end of the core 12. Three hooks 32 set on one side of the driven device 30 around the axle hole 31. The free ends of the hooks are bended inward to the axle hole 31. The driven device 30 mounts on the back wheel hub 10 of the bicycle by the axle hole 31 thereof engaging with the core 12 at the opposite side thereof from a chain (not shown) of the bicycle. The driven device 30 is attached on the exterior side of the disk 13 of the back wheel hub 10 with the hooks 32 hooking the disk 13. Three secure pieces 33 attach at the interior side of the disk 13 at the position of between the hooks 32 (shown in FIG. 4) respectively. The secure pieces 33 have bolts screwing with the driven device 30 to secure the driven device 30 on the disk 13 of the back wheel hub 10. The first embodiment further has a cover 35, which has a ring segment 35 at the interior side thereof. The ring segment 35 has a slot therein corresponding to the core 13 of the back wheel hub 10. The cover 35 is secured by the ring segment 35 inserts into the space between the core 13 and the axle hole 31 of the driven device 30 and by means of bolts screwing with the driven device 30. The cover 35 is to provide the driven device 30 an extra locking force for preventing the driven device 30 escaping from the back wheel hub 10.

A motor 40 fixes on the skeleton 15 of the bicycle at the same side as the driven device 30. In the present embodiment, we provide a seat 41 of L-shaped and has C-rings 42 at the interior side thereof. The C-rings 42 are to engage with the skeleton 15 of the bicycle and then having bolts lock at the opening ends of the C-rings 42 to secure the seat 41 on the skeleton 15. The motor 40 fixes at the seat 41 with the output axle 43 thereof orientating inwards and being parallel to the back wheel hub 10.

A transmission assembly 50 is to transmit the turning power of the motor 40 to the driven device 30. In the present embodiment, the transmission assembly 50 is a driving gear, which has teeth thereon less than the driven device 30, mounting on the output axle 43 of the motor 40 and engaging to the driven device 30.

In practice, there is a battery (not shown in FIG.) mounting on the bicycle to provide the motor 40 an electrical power. The handle of the bicycle usually mounts with a controller (not shown in FIG.) to turn on or turn off the motor 40 and to adjust the output power of the motor 40. These two elements are not the main characteristic of the present invention. Prior art had been provided many types of the battery and the controller, and manufacturer is easily to set them on the bicycle. So, allow me not to describe them in detail.

When a rider turns on the power, the motor 40 will turn and drive the back wheel hub 10 to turn via the transmission assembly 50 and the driven device 30. In the mean time, the back wheel of the bicycle will be turned to force the bicycle traveling forward. Because the teeth of the transmission assemble 50 are less than the teeth of the driven device 30, the electrical driving apparatus 20 of the present invention can provide the bicycle a larger torque when traveling.

In the conventional bicycle, there is an over running clutch (not shown) between the back wheel hub 10 and the back wheel. The over running clutch is to make the back wheel hub 10 turning forward, when rider forces the crank (not shown) to turn. But the back wheel hub 10 cannot drive the crank to turn. For the electrical driving apparatus 20 is driving the back wheel hub 10 to turn directly. Whereby, when the electrical driving apparatus 20 of the present invention drives the bicycle to travel, the crank will not be turned along.

The advantages of the present invention are, the electrical driving apparatus 20 is easy to assemble on any type of a conventional bicycle by a general user to transfer a normal bicycle into an electrical driving bicycle. And furthermore, the electrical driving apparatus 20 of the present invention has a simpler structure and a lower manufacture cost.

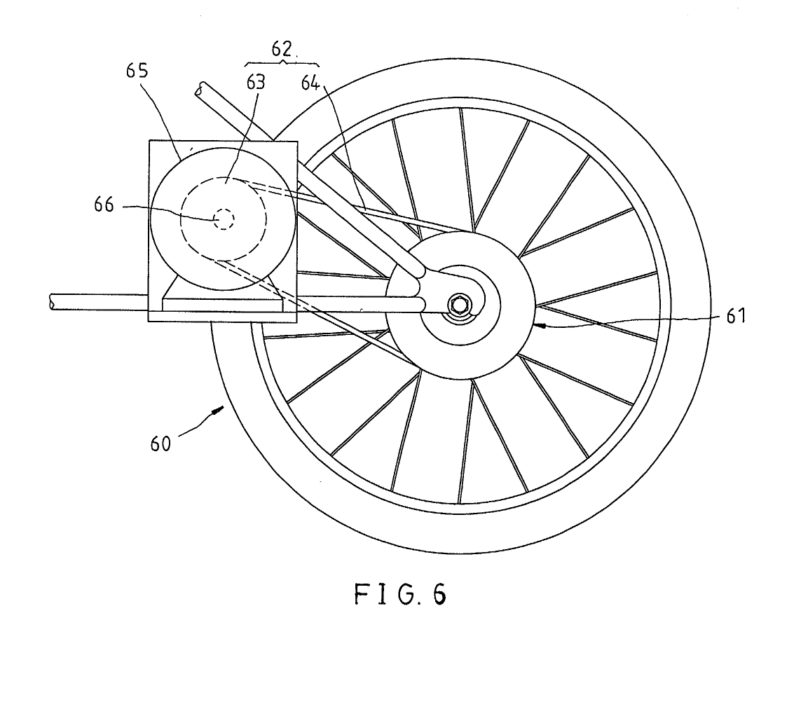

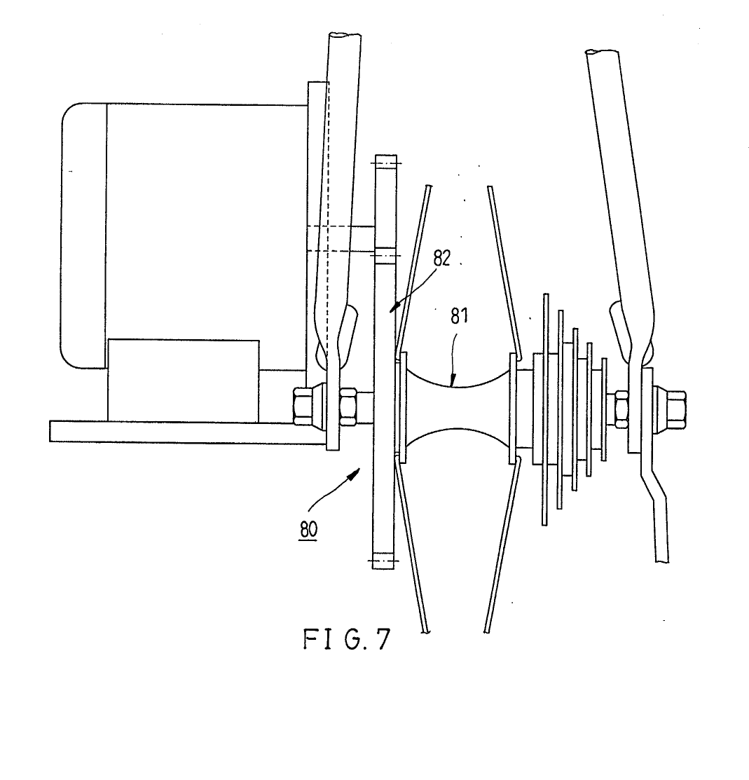

Now please refer to FIG. 6, which shows an electrical driving apparatus 60 of the second prefer embodiment of the present invention. The structure of the electrical driving apparatus 60 of the second prefer embodiment is mainly as same as the first prefer embodiment, except that the driven device 61 of the second prefer embodiment is a driven pulley. The transmission assembly 50 has a driving pulley 63 mounting at the output axle 66 of the motor 65 and a belt 64 engaging with the driving pulley 63 and the driven device 61. Thus, the electrical driving apparatus 60 of the second prefer embodiment has the same function as the first prefer embodiment.

An electrical driving apparatus 80 of the third prefer embodiment of the present invention is shown in FIG. 7. It is mainly as same as the first prefer embodiment of the present invention too. The only difference is when manufacturing the back wheel hub 81, a driven device 82 is formed as an unity at one side thereof. Thus, there are no need of the securing pieces and the cover as described in the first prefer embodiment to secure the driven device 82 in the third prefer embodiment.

What is claimed is:

1. An electrical driving apparatus, which is to mount on a bicycle for driving the bicycle to travel, comprising:
a driven device being for securing at one side of a back wheel hub of the bicycle;
a motor being for mounting on a predetermined position of a skeleton of the bicycle; said motor can provide a turning power by an electrical power, and
means for transmitting the turning power of said motor to said driven device to drive the bicycle traveling forward.

2. The electrical driving apparatus as defined in claim 1, wherein said driven device is a driven gear; a driving gear mounting on the output axle of said motor; said driven device engaging with said driving gear to transmit the turning power of said motor to said driven device; the teeth of said driven device are less than the teeth of said driving gear.

3. The electrical driving apparatus in claim 1, wherein said driven device is a driven pulley; a driving pulley mounting on the output axle of said motor; a belt engaging with said driven device and said driving pulley to transmit the turning power of said motor to said driven device; the diameter of said driven device is smaller than the diameter of said driving pulley.

4. The electrical driving apparatus as defined in claim 1, wherein said driven device having an axial hole at central thereof and hooks at one side thereof around said axial hole; the free ends of said hooks being bended inward to said axial hole; said driven device being for securing at one side of the back wheel hub of the bicycle by means of a core of the back wheel hub receiving in said axial hole and said hooks locking at a disk of the back wheel hub; a plurality of secure pieces being for attaching on the interior side of the disk of the back wheel hub and securing to said driven device by means of at least one bolt.

5. The electrical driving apparatus as defined in claim 4, wherein further comprising a cover having a ring segment at one side thereof; said cover covering on said driven device by means of said ring segment inserting into the space between said axial hole of said driven device and the core of the back wheel hub; said cover further securing with said driven device by at least one bolt.

6. The electrical driving apparatus as defined in claim 1, wherein said driven device forming on the back wheel hub as a unity.

7. The electrical driving apparatus as defined in claim 1, wherein further comprising a seat securing on a skeleton of the bicycle; said motor mounting on said seat.

8. The electrical driving apparatus as defined in claim 1, wherein said driven device being for mounting on the back wheel hub at the side of opposite from a chain of the bicycle.
